(19) United States
(12) Patent Application Publication
(10) Pub. No.: US 2024/0151609 A1
(43) Pub. Date: May 9, 2024

(54) METHOD OF SELECTING OPTIMIZED MULTIMODE OPTICAL FIBERS

(71) Applicant: CORNING INCORPORATED, Corning, NY (US)

(72) Inventors: Zoren Dene Bullock, Newfield, NY (US); Xin Chen, Painted Post, NY (US); Hao Dong, Horseheads, NY (US); Ming-Jun Li, Horseheads, NY (US); Simit Mayank Patel, Greensboro, NC (US)

(21) Appl. No.: 18/490,897

(22) Filed: Oct. 20, 2023

Related U.S. Application Data
(60) Provisional application No. 63/449,452, filed on Mar. 2, 2023.
(60) Provisional application No. 63/423,704, filed on Nov. 8, 2022.

(51) Int. Cl. G01M 11/00

(52) U.S. Cl. CPC G01M 11/30

(57) ABSTRACT

A method of selecting a group of multimode optical fibers, includes comparing a first effective modal bandwidth at a first wavelength of a multimode optical fiber with a first effective modal bandwidth threshold at the first wavelength, the multimode optical fiber being in a group of multimode optical fibers meeting a first OM standard, wherein the first wavelength is from 844 nm to 863 nm; and categorizing the multimode optical fiber as passing a transmission distance requirement if the first effective modal bandwidth of the first multimode optical fiber is greater than or equal to the first effective modal bandwidth threshold; wherein the transmission distance is defined in a transceiver specification, wherein the transceiver specification is one or more of: (a) an 800G bidirectional (BiDi) transceiver specification, or (b) a 100G/lane based MM VCSEL transceiver specification, or (c) a 25Gbaud based transceiver specification, or (d) 50G PAM4 based transceiver specification.

### CROSS-REFERENCE TO RELATED APPLICATIONS

This application claims the benefit of priority of U.S. Provisional Application Ser. No. 63/449,452 filed on Mar. 2, 2023, and U.S. Provisional Application Ser. No. 63/423,704 filed on Nov. 8, 2022, the contents of which are relied upon and incorporated herein by reference in their entireties.

### FIELD OF THE DISCLOSURE

The present disclosure relates to optical fibers and in particular relates to systems and methods for selecting optimized multimode optical fibers.

### BACKGROUND OF THE DISCLOSURE

Multimode optical fibers (MMF) used with short-wavelength VCSELs (vertical cavity surface emitting lasers) have emerged as a dominant technology for short-reach, high data rate networks. Examples of such networks include office buildings and data centers. Single mode optical fibers can achieve much greater data rates and transmission lengths than multimode optical fibers. But a short-reach, high data rate network using single mode optical fibers requires that the fibers are coupled with lasers, splices, and connectors, thus resulting in a more expensive network than a short-reach, high data rate network using multimode optical fibers coupled with VCSELs. Also, an MMF based solution exhibits lower power consumption, which is associated with the low power and low lasing threshold nature of VCSEL-based multimode transceivers. So, multimode fibers provide an effective low-cost, low-power optical connectivity solution for such short-reach, high data networks.

Multimode fibers operating at 850 nm are currently a leading optical media used in short-reach, high data rate networks. Such multimode fibers are classified under certain International Organization for Standardization (ISO) standards based on the effective modal bandwidth (EMB), which is measured in units of frequency×distance, e.g., MHz·km. The classifications are referred to using the acronym OM (“optical multimode”), with the present OM standards being OM1, OM2, OM3, OM4, and OM5. Each OM standard may have different physical characteristics (e.g., core radius, cladding radius, relative refractive index profile, etc) that result in different characteristics, including different EMB. OM1 fiber has a core diameter of 62.5 microns. The multimode fibers used today are dominantly 50 microns core multimode fibers as categorized as OM2, OM3, OM4 and OM5. It is noted that the OM5 standard includes all of the requirements of the OM4 standard, plus additional minimum bandwidth requirements at 953 nm. The OM5 standard is designed for Shortwave Wavelength Division Multiplexing (SWDM) applications which extends from 850 nm to 953 nm wavelength. OM3 meets the EMB of 2000 MHz·km at 850 nm while OM4 meets the EMB of 4700 MHz·km at 850 nm.

For 25 Gbaud based transmission, OM3 and OM4 are the two primary types of MMFs with OM3 covering 70 m reach (i.e., distance) and OM4 covering 100 m reach. The details are listed in Table 1 for various types of multimode transceivers based on 25Gbaud symbol rate. The industry is moving toward 100G/lane for VCSEL based transceivers using either 850 nm only wavelength or 850 nm/910 nm wavelength for Wavelength Division Multiplexing (WDM) transmission. The RMS laser linewidth is specified as 0.60 nm or less. With the introduction of 100G/lane, the system reach may be reduced due to bandwidth limitation at 850 nm and/or at 910 nm. For 800G BiDi MSA or Terabit BiDi MSA, the reach specifications for OM3 and OM4 transmission are expected to be 45 m and 70 m respectively for SR type of transceivers. The RMS laser line width is specified to be a maximum of 0.60 nm in the 850 nm wavelength window and a maximum of 0.58 nm in the 910 nm wavelength window. For VR type transceivers, the RMS laser line width is specified as a maximum of 0.65 nm in the 850 nm wavelength window and a maximum of 0.60 nm in the 910 nm wavelength window. For transmission only in the 850 nm wavelength window, transmission using 100G SR, 200G SR2, 400G SR4 and 800G SR8, OM3 and OM4 are expected to transmit 60 m and 100 m, respectively. OM3 suffers from reduced system reach due to its modal bandwidth limitation around 850 nm. Table 2 shows the system reach information for 100G/lane-based transceivers and illustrates the reach limitation over those listed on Table 1 for 25Gbaud based transceivers.

TABLE 1
System reaches for 25Gbaud based VCSEL transceivers

| | 25G | 100G | 100G | 100G | 400G | 400G |
|---|---|---|---|---|---|---|
| | SR | SR4 | BiDi | SWDM4 | SR8 | SR4.2 |
| MSA/ | IEEE | IEEE | — | MSA | IEEE | MSA/IEEE |
| Standard | 802.3 by | 802.3 bm | | | 802.3 cm | 802.3 cm |
| OM3 Reach | 70 m | 70 m | 70 m | 75 m | 70 m | 70 m |
| OM4 Reach | 100 m | 100 m | 100 m | 100 m | 100 m | 100 m |
| Fiber Count | 2 | 8 | 2 | 2 | 16 | 8 |

TABLE 2
System reaches for 100G/lane based VCSEL transceivers

| | 100G | 200G | 400G | 800G BiDi |
|---|---|---|---|---|
| | VR/SR | VR2/SR2 | VR4/SR4 | SR4.2 |
| MSA/Standard | IEEE802.3 db | IEEE802.3 db | IEEE802.3 db | Terabit BiDi |
| OM3 Reach | 30 m/60 m | 30 m/60 m | 30 m/60 m | 45 m |
| OM4 Reach | 50 m/100 m | 50 m/100 m | 50 m/100 m | 70 m |
| Fiber Count | 2 | 4 | 8 | 8 |

As the industry has become accustomed to 70 meters OM3 and 100 meters OM4 transmission for several generations of transceivers based on 25Gbaud data rate, data centers have been designed around the 70 meter and 100 meter reaches. Some users prefer 70 meters reach using OM3 for cost-savings reasons and the 70 meters reach fits the dimension used in the specific applications, while other users use both OM3 and OM4 to address the distance they need. However, at 100G/lane, in particular 800G BiDi, the reaches have been dramatically reduced. This would pose challenges for continued use of MMFs.

### SUMMARY OF THE DISCLOSURE

A first embodiment of the present disclosure includes a method of selecting a group of multimode optical fibers, wherein the method includes comparing a first effective modal bandwidth at a first wavelength of a multimode optical fiber with a first effective modal bandwidth threshold at the first wavelength, the multimode optical fiber being in a group of multimode optical fibers meeting a first OM standard, wherein the first wavelength is from 844 nm to 863 nm; and categorizing the multimode optical fiber as passing a transmission distance requirement if the first effective modal bandwidth of the first multimode optical fiber is greater than or equal to the first effective modal bandwidth threshold; wherein the transmission distance is defined in a transceiver specification, wherein the transceiver specification is one or more of: (a) an 800G bidirectional (BiDi) transceiver specification, or (b) a 100G/lane based MM VCSEL transceiver specification, or (c) a 25Gbaud based transceiver specification, or (d) 50G PAM4 based transceiver specification.

A second embodiment of the present disclosure may include the first embodiment, further including comparing a second effective modal bandwidth at a second wavelength of the multimode optical fiber with a second effective modal bandwidth threshold at the second wavelength, the multimode optical fiber being in a group of multimode optical fibers meeting the first OM standard, wherein the second wavelength is from 900 nm to 915 nm; and
categorizing the multimode optical fiber as passing the transmission distance requirement if the first effective modal bandwidth of the first multimode optical fiber is greater than or equal to the first effective modal bandwidth threshold and the second effective modal bandwidth of the first multimode optical fiber is greater than or equal to the second effective modal bandwidth threshold.

A third embodiment of the present disclosure may include the any one of the first or second embodiment, wherein the first OM-standard is an OM3-standard.

A fourth embodiment of the present disclosure may include the any one of the first or second embodiment, wherein the first OM-standard is an OM4-standard.

A fifth embodiment of the present disclosure may include any one of the first or second embodiment, wherein the transmission distance is greater than or equal to 70 meters, or greater than or equal to 80 meters, or greater than or equal to 85 meters, or greater than or equal to 90 meters, or greater than or equal to 100 meters, or greater than or equal to 150 meters.

A sixth embodiment of the present disclosure may include the any one of the first or second embodiment, wherein the transmission distance is 70 meters.

A seventh embodiment of the present disclosure may include the any one of the first or second embodiment, wherein the transmission distance is 80 meters.

An eighth embodiment of the present disclosure may include the any one of the first or second embodiment, wherein the transmission distance is 85 meters.

A ninth embodiment of the present disclosure may include the any one of the first or second embodiment, wherein the transmission distance is 90 meters.

A tenth embodiment of the present disclosure may include the any one of the first or second embodiment, wherein the transmission distance is 100 meters.

An eleventh embodiment of the present disclosure may include the first embodiment, wherein the transmission distance is 70 meters, the first wavelength is 850 nm, and the first effective modal bandwidth threshold is 2310 MHz·km when the first wavelength is provided by a laser having an RMS line width of 0.60 nm or less.

A twelfth embodiment of the present disclosure may include the first embodiment wherein the transmission distance is 80 meters, the first wavelength is 850 nm, and the first effective modal bandwidth threshold is 2890 MHz·km when the first wavelength is provided by a laser having an RMS line width of 0.60 nm or less.

A thirteenth embodiment of the present disclosure may include the first embodiment wherein the transmission distance is greater than or equal to 100 meters, such as 122 meters, the first wavelength is 850 nm, and the first effective modal bandwidth threshold is 2890 MHz·km when the first wavelength is provided by a laser having an RMS line width of 0.60 nm or less.

A fourteenth embodiment of the present disclosure may include the first embodiment wherein the transmission distance is 85 meters, the first wavelength is 850 nm, and the first effective modal bandwidth threshold is 3240 MHz·km when the first wavelength is provided by a laser having an RMS line width of 0.60 nm or less.

A fifteenth embodiment of the present disclosure may include the first embodiment, wherein the transmission distance is 90 meters, the first wavelength is 850 nm, and the first effective modal bandwidth threshold is 3642 MHz·km when the first wavelength is provided by a laser having an RMS line width of 0.60 nm or less.

A sixteenth embodiment of the present disclosure may include the first embodiment, wherein the transmission distance is 90 meters, the first wavelength is 850 nm, and the first effective modal bandwidth threshold is 3640 MHz·km when the first wavelength is provided by a laser having an RMS line width of 0.60 nm or less.

A seventeenth embodiment of the present disclosure may include the second embodiment, wherein the transmission distance is 70 meters, the first wavelength is 850 nm, the second wavelength is 910 nm, the first effective modal bandwidth threshold is 2310 MHz·km when the first wavelength is provided by a laser having an RMS line width of 0.60 nm or less and the second effective modal bandwidth threshold is 1898 MHz·km when the second wavelength is provided by a laser having an RMS line width of 0.58 nm or less.

An eighteenth embodiment of the present disclosure may include the second embodiment, wherein the transmission distance is 70 meters, the first wavelength is 850 nm, the second wavelength is 910 nm, the first effective modal bandwidth threshold is 2310 MHz·km when the first wavelength is provided by a laser having an RMS line width of 0.60 nm or less and the second effective modal bandwidth threshold is 1890 MHz·km when the second wavelength is provided by a laser having an RMS line width of 0.58 nm or less.

A nineteenth embodiment of the present disclosure may include the second embodiment, wherein the transmission distance is 80 meters, the first wavelength is 850 nm, the second wavelength is 910 nm, the first effective modal bandwidth threshold is 2890 MHz·km when the first wavelength is provided by a laser having an RMS line width of 0.60 nm or less and the second effective modal bandwidth threshold is 2243 MHz·km when the second wavelength is provided by a laser having an RMS line width of 0.58 nm or less.

A twentieth embodiment of the present disclosure may include the second embodiment, wherein the transmission distance is 80 meters, the first wavelength is 850 nm, the second wavelength is 910 nm, the first effective modal bandwidth threshold is 2890 MHz·km when the first wavelength is provided by a laser having an RMS line width of 0.60 nm or less and the second effective modal bandwidth threshold is 2220 MHz·km when the second wavelength is provided by a laser having an RMS line width of 0.58 nm or less.

A twenty-first embodiment of the present disclosure may include the second embodiment, wherein the transmission distance is greater than or equal to 100 meters, such as 122 meters, the first wavelength is 850 nm, the second wavelength is 910 nm, the first effective modal bandwidth threshold is 2890 MHz·km when the first wavelength is provided by a laser having an RMS line width of 0.60 nm or less and the second effective modal bandwidth threshold is 2220 MHz·km when the second wavelength is provided by a laser having an RMS line width of 0.60 nm or less.

A twenty-second embodiment of the present disclosure may include the second embodiment, wherein the transmission distance is 85 meters, the first wavelength is 850 nm, the second wavelength is 910 nm, the first effective modal bandwidth threshold is 3240 MHz·km when the first wavelength is provided by a laser having an RMS line width of 0.60 nm or less and the second effective modal bandwidth threshold is 2429 MHz·km when the second wavelength is provided by a laser having an RMS line width of 0.58 nm or less.

A twenty-third embodiment of the present disclosure may include the second embodiment, wherein the transmission distance is 85 meters, the first wavelength is 850 nm, the second wavelength is 910 nm, the first effective modal bandwidth threshold is 3240 MHz·km when the first wavelength is provided by a laser having an RMS line width of 0.60 nm or less and the second effective modal bandwidth threshold is 2400 MHz·km when the second wavelength is provided by a laser having an RMS line width of 0.58 nm or less.

An twenty-fourth embodiment of the present disclosure may include the second embodiment, wherein the transmission distance is 90 meters, the first wavelength is 850 nm, the second wavelength is 910 nm, the first effective modal bandwidth threshold is 3642 MHz·km when the first wavelength is provided by a laser having an RMS line width of 0.60 nm or less and the second effective modal bandwidth threshold is 2627 MHz·km when the second wavelength is provided by a laser having an RMS line width of 0.58 nm or less.

An twenty-fifth embodiment of the present disclosure may include the second embodiment, wherein the transmission distance is 90 meters, the first wavelength is 850 nm, the second wavelength is 910 nm, the first effective modal bandwidth threshold is 3640 MHz·km when the first wavelength is provided by a laser having an RMS line width of 0.60 nm or less and the second effective modal bandwidth threshold is 2600 MHz·km when the second wavelength is provided by a laser having an RMS line width of 0.58 nm or less.

A twenty-sixth embodiment of the present disclosure may include the second embodiment, wherein the transmission distance is 100 meters, the first wavelength is 850 nm, the second wavelength is 910 nm, the first effective modal bandwidth threshold is 4700 MHz·km when the first wavelength is provided by a laser having an RMS line width of 0.60 nm or less and wherein the second effective modal bandwidth threshold is 3067 MHz·km when the second wavelength is provided by a laser having an RMS line width of 0.58 nm or less.

A twenty-seventh embodiment of the present disclosure may include the second embodiment, wherein the transmission distance is 100 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3010 MHz·km when the second wavelength is provided by a laser having an RMS line width of 0.58 nm or less.

A twenty-eighth embodiment of the present disclosure may include the second embodiment, wherein the transmission distance is greater than or equal to 150 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3010 MHz·km when the second wavelength is provided by a laser having an RMS line width of 0.60 nm or less.

A twenty-ninth embodiment of the present disclosure may include the second embodiment, wherein the transmission distance is 100 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3100 MHz·km when the second wavelength is provided by a laser having an RMS line width of 0.58 nm or less.

A thirtieth embodiment of the present disclosure may include the second embodiment, wherein the transmission distance is greater than or equal to 150 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3100 MHz·km when the second wavelength is provided by a laser having an RMS line width of 0.60 nm or less.

A thirty-first embodiment of the present disclosure may include the second embodiment, wherein the transmission distance is 70 meters, wherein the first effective modal bandwidth threshold is one of: (a) 2083.8 MHz·km when the first wavelength is 844 nm and the first wavelength is provided by a laser having an RMS line width of 0.60 nm or less, (b) 2059.3 MHz·km when the first wavelength is 850 nm and the first wavelength is provided by a laser having an RMS line width of 0.60 nm or less, (c) 2033 MHz·km when the first wavelength is 857 nm and the first wavelength is provided by a laser having an RMS line width of 0.60 nm or less, or (d) 2013 MHz·km when the first wavelength is 863 nm and the first wavelength is provided by a laser having an RMS line width of 0.60 nm or less, and wherein the second effective modal bandwidth threshold is one of: (a) 1917.6 MHz·km when the second wavelength is 900 nm and the second wavelength is provided by a laser having an RMS line width of 0.58 nm or less, (b) 1907.7 MHz·km when the second wavelength is 905 nm and the second wavelength is provided by a laser having an RMS line width of 0.58 nm or less, (c) 1898.4 MHz·km when the second wavelength is 910 nm and the second wavelength is provided by a laser having an RMS line width of 0.58 nm or less, (d) 1889.6 MHz·km when the second wavelength is 915 nm and the second wavelength is provided by a laser having an RMS line width of 0.58 nm or less.

A thirty-second embodiment of the present disclosure may include the second embodiment, wherein the transmission distance is 70 meters, wherein the first effective modal bandwidth threshold is one of: (a) 2084 MHz·km at the first wavelength of 844 nm when the first wavelength is 844 nm and the first wavelength is provided by a laser having an RMS line width of 0.60 nm or less, (b) 2059 MHz·km when the first wavelength is 850 nm and the first wavelength is provided by a laser having an RMS line width of 0.60 nm or less, (c) 2033 MHz·km when the first wavelength is 857 nm and the first wavelength is provided by a laser having an RMS line width of 0.60 nm or less, or (d) 2013 MHz·km when the first wavelength is 863 nm and the first wavelength is provided by a laser having an RMS line width of 0.60 nm or less, and wherein the second effective modal bandwidth threshold is one of: (a) 1903 MHz·km when the second wavelength is 900 nm and the second wavelength is provided by a laser having an RMS line width of 0.58 nm or less, (b) 1894 MHz·km when the second wavelength is 905 nm and the second wavelength is provided by a laser having an RMS line width of 0.58 nm or less, (c) 1886 MHz·km when the second wavelength is 910 nm and the second wavelength is provided by a laser having an RMS line width of 0.58 nm or less, (d) 1877 MHz·km when the second wavelength is 915 nm and the second wavelength is provided by a laser having an RMS line width of 0.58 nm or less.

A thirty-third embodiment of the present disclosure may include the second embodiment, wherein the transmission distance is 80 meters, wherein the first effective modal bandwidth threshold is one of: (a) 2568.2 MHz·km when the first wavelength is 844 nm and the first wavelength is provided by a laser having an RMS line width of 0.60 nm or less, (b) 2522.7 MHz·km when the first wavelength is 850 nm and the first wavelength is provided by a laser having an RMS line width of 0.60 nm or less, (c) 2475.4 MHz·km when the first wavelength is 857 nm and the first wavelength is provided by a laser having an RMS line width of 0.60 nm or less, or (d) 2438.9 MHz·km when the first wavelength is 863 nm and the first wavelength is provided by a laser having an RMS line width of 0.60 nm or less, and wherein the second effective modal bandwidth threshold is one of: (a) 2274.6 MHz·km when the second wavelength is 900 nm and the second wavelength is provided by a laser having an RMS line width of 0.58 nm or less, (b) 2258.2 MHz·km when the second wavelength is 905 nm and the second wavelength is provided by a laser having an RMS line width of 0.58 nm or less, (c) 2242.8 MHz·km when the second wavelength is 910 nm and the second wavelength is provided by a laser having an RMS line width of 0.58 nm or less, (d) 2228.4 MHz·km when the second wavelength is 915 nm and the second wavelength is provided by a laser having an RMS line width of 0.58 nm or less.

A thirty-fourth embodiment of the present disclosure may include the second embodiment, wherein the transmission distance is 80 meters, wherein the first effective modal bandwidth threshold is one of: (a) 2568 MHz·km when the first wavelength is 844 nm and the first wavelength is provided by a laser having an RMS line width of 0.60 nm or less, (b) 2523 MHz·km when the first wavelength is 850 nm and the first wavelength is provided by a laser having an RMS line width of 0.60 nm or less, (c) 2475 MHz·km when the first wavelength is 857 nm and the first wavelength is provided by a laser having an RMS line width of 0.60 nm or less, or (d) 2439 MHz·km when the first wavelength is 863 nm and the first wavelength is provided by a laser having an RMS line width of 0.60 nm or less, and wherein the second effective modal bandwidth threshold is one of: (a) 2250 MHz·km when the second wavelength is 900 nm and the second wavelength is provided by a laser having an RMS line width of 0.58 nm or less, (b) 2236 MHz·km when the second wavelength is 905 nm and the second wavelength is provided by a laser having an RMS line width of 0.58 nm or less, (c) 2222 MHz·km when the second wavelength is 910 nm and the second wavelength is provided by a laser having an RMS line width of 0.58 nm or less, (d) 2208 MHz·km when the second wavelength is 915 nm and the second wavelength is provided by a laser having an RMS line width of 0.58 nm or less.

A thirty-fifth embodiment of the present disclosure may include the second embodiment, wherein the transmission distance is greater than or equal to 100 meters, wherein the first effective modal bandwidth threshold is one of: (a) 2568 MHz·km when the first wavelength is 844 nm and the first wavelength is provided by a laser having an RMS line width of 0.60 nm or less, (b) 2523 MHz·km when the first wavelength is 850 nm and the first wavelength is provided by a laser having an RMS line width of 0.60 nm or less, (c) 2475 MHz·km when the first wavelength is 857 nm and the first wavelength is provided by a laser having an RMS line width of 0.60 nm or less, or (d) 2439 MHz·km when the first wavelength is 863 nm and the first wavelength is provided by a laser having an RMS line width of 0.60 nm or less, and wherein the second effective modal bandwidth threshold is one of: (a) 2250 MHz·km when the second wavelength is 900 nm and the second wavelength is provided by a laser having an RMS line width of 0.60 nm or less, (b) 2236 MHz·km when the second wavelength is 905 nm and the second wavelength is provided by a laser having an RMS line width of 0.60 nm or less, (c) 2222 MHz·km when the second wavelength is 910 nm and the second wavelength is provided by a laser having an RMS line width of 0.60 nm or less, (d) 2208 MHz·km when the second wavelength is 915 nm and the second wavelength is provided by a laser having an RMS line width of 0.60 nm or less.

A thirty-sixth embodiment of the present disclosure may include the second embodiment, wherein the transmission distance is 85 meters, the first effective modal bandwidth threshold is one of: (a) 2860 MHz·km when the first wavelength is 844 nm and the first wavelength is provided by a laser having an RMS line width of 0.60 nm or less, (b) 2797 MHz·km when the first wavelength is 850 nm and the first wavelength is provided by a laser having an RMS line width of 0.60 nm or less, (c) 2733 MHz·km when the first wavelength is 857 nm and the first wavelength is provided by a laser having an RMS line width of 0.60 nm or less, or (d) 2684 MHz·km when the first wavelength is 863 nm and the first wavelength is provided by a laser having an RMS line width of 0.60 nm or less, and wherein the second effective modal bandwidth threshold is one of: (a) 2470 MHz·km when the second wavelength is 900 nm and the second wavelength is provided by a laser having an RMS line width of 0.58 nm or less, (b) 2449 MHz·km when the second wavelength is 905 nm and the second wavelength is provided by a laser having an RMS line width of 0.58 nm or less, (c) 2429 MHz·km when the second wavelength is 910 nm and the second wavelength is provided by a laser having an RMS line width of 0.58 nm or less, (d) 2411 MHz·km when the second wavelength is 915 nm and the second wavelength is provided by a laser having an RMS line width of 0.58 nm or less.

A thirty-seventh embodiment of the present disclosure may include the second embodiment, wherein the transmission distance is 85 meters, the first effective modal bandwidth threshold is one of: (a) 2860 MHz·km when the first wavelength is 844 nm and the first wavelength is provided by a laser having an RMS line width of 0.60 nm or less, (b) 2797 MHz·km when the first wavelength is 850 nm and the first wavelength is provided by a laser having an RMS line width of 0.60 nm or less, (c) 2733 MHz·km when the first wavelength is 857 nm and the first wavelength is provided by a laser having an RMS line width of 0.60 nm or less, or (d) 2684 MHz·km when the first wavelength is 863 nm and the first wavelength is provided by a laser having an RMS line width of 0.60 nm or less, and wherein the second effective modal bandwidth threshold is one of: (a) 2439 MHz·km when the second wavelength is 900 nm and the second wavelength is provided by a laser having an RMS line width of 0.58 nm or less, (b) 2420 MHz·km when the second wavelength is 905 nm and the second wavelength is provided by a laser having an RMS line width of 0.58 nm or less, (c) 2462 MHz·km when the second wavelength is 910 nm and the second wavelength is provided by a laser having an RMS line width of 0.58 nm or less, (d) 2386 MHz·km when the second wavelength is 915 nm and the second wavelength is provided by a laser having an RMS line width of 0.58 nm or less.

A thirty-eighth embodiment of the present disclosure may include the second embodiment, wherein the transmission distance is 90 meters, the first effective modal bandwidth threshold is one of: (a) 3199.5 MHz·km when the first wavelength is 844 nm and the first wavelength is provided by a laser having an RMS line width of 0.60 nm or less, (b) 3112.94 MHz·km when the first wavelength is 850 nm and the first wavelength is provided by a laser having an RMS line width of 0.60 nm or less, (c) 3025.2 MHz·km when the first wavelength is 857 nm and the first wavelength is provided by a laser having an RMS line width of 0.60 nm or less, or (d) 2959.48 MHz·km when the first wavelength is 863 nm and the first wavelength is provided by a laser having an RMS line width of 0.60 nm or less, and wherein the second effective modal bandwidth threshold is one of: (a) 2679 MHz·km when the second wavelength is 900 nm and the second wavelength is provided by a laser having an RMS line width of 0.58 nm or less, (b) 2652 MHz·km when the second wavelength is 905 nm and the second wavelength is provided by a laser having an RMS line width of 0.58 nm or less, (c) 2627 MHz·km when the second wavelength is 910 nm and the second wavelength is provided by a laser having an RMS line width of 0.58 nm or less, (d) 2604 MHz·km when the second wavelength is 915 nm and the second wavelength is provided by a laser having an RMS line width of 0.58 nm or less.

A thirty-ninth embodiment of the present disclosure may include the second embodiment, wherein the transmission distance is 90 meters, the first effective modal bandwidth threshold is one of: (a) 3200 MHz·km when the first wavelength is 844 nm and the first wavelength is provided by a laser having an RMS line width of 0.60 nm or less, (b) 3113 MHz·km when the first wavelength is 850 nm and the first wavelength is provided by a laser having an RMS line width of 0.60 nm or less, (c) 3025 MHz·km when the first wavelength is 857 nm and the first wavelength is provided by a laser having an RMS line width of 0.60 nm or less, or (d) 2959 MHz·km when the first wavelength is 863 nm and the first wavelength is provided by a laser having an RMS line width of 0.60 nm or less, and wherein the second effective modal bandwidth threshold is one of: (a) 2640 MHz·km when the second wavelength is 900 nm and the second wavelength is provided by a laser having an RMS line width of 0.58 nm or less, (b) 2616 MHz·km when the second wavelength is 905 nm and the second wavelength is provided by a laser having an RMS line width of 0.58 nm or less, (c) 2593 MHz·km when the second wavelength is 910 nm and the second wavelength is provided by a laser having an RMS line width of 0.58 nm or less, (d) 2573 MHz·km when the second wavelength is 915 nm and the second wavelength is provided by a laser having an RMS line width of 0.58 nm or less.

A fortieth embodiment of the present disclosure may include the second embodiment, wherein the transmission distance is 100 meters, the first effective modal bandwidth threshold is one of: (a) 4113 MHz·km when the first wavelength is 844 nm and the first wavelength is provided by a laser having an RMS line width of 0.60 nm or less, (b) 3934 MHz·km when the first wavelength is 850 nm and the first wavelength is provided by a laser having an RMS line width of 0.60 nm or less, (c) 3761 MHz·km when the first wavelength is 857 nm and the first wavelength is provided by a laser having an RMS line width of 0.60 nm or less, or (d) 3637 MHz·km when the first wavelength is 863 nm and the first wavelength is provided by a laser having an RMS line width of 0.60 nm or less, and wherein the second effective modal bandwidth threshold is one of: (a) 3150 MHz·km when the second wavelength is 900 nm and the second wavelength is provided by a laser having an RMS line width of 0.58 nm or less, (b) 3107 MHz·km when the second wavelength is 905 nm and the second wavelength is provided by a laser having an RMS line width of 0.58 nm or less, (c) 3067 MHz·km when the second wavelength is 910 nm and the second wavelength is provided by a laser having an RMS line width of 0.58 nm or less, (d) 3031 MHz·km when the second wavelength is 915 nm and the second wavelength is provided by a laser having an RMS line width of 0.58 nm or less.

A forty-first embodiment of the present disclosure may include the second embodiment, wherein the transmission distance is 100 meters, the first effective modal bandwidth threshold is one of: (a) 4113 MHz·km when the first wavelength is 844 nm and the first wavelength is provided by a laser having an RMS line width of 0.60 nm or less, (b) 3934 MHz·km when the first wavelength is 850 nm and the first wavelength is provided by a laser having an RMS line width of 0.60 nm or less, (c) 3761 MHz·km when the first wavelength is 857 nm and the first wavelength is provided by a laser having an RMS line width of 0.60 nm or less, or (d) 3637 MHz·km when the first wavelength is 844 nm and the first wavelength is provided by a laser having an RMS line width of 0.60 nm or less, and wherein the second effective modal bandwidth threshold is one of: (a) 3087 MHz·km when the second wavelength is 900 nm and the second wavelength is provided by a laser having an RMS line width of 0.58 nm or less, (b) 3049 MHz·km when the second wavelength is 905 nm and the second wavelength is provided by a laser having an RMS line width of 0.58 nm or less, (c) 3014 MHz·km when the second wavelength is 910 nm and the second wavelength is provided by a laser having an RMS line width of 0.58 nm or less, (d) 2981 MHz·km when the second wavelength is 915 nm and the second wavelength is provided by a laser having an RMS line width of 0.58 nm or less.

A forty-second embodiment of the present disclosure may include the second embodiment, wherein the transmission distance is greater than or equal to 150 meters, the first effective modal bandwidth threshold is one of: (a) 4113 MHz·km when the first wavelength is 844 nm and the first wavelength is provided by a laser having an RMS line width of 0.60 nm or less, (b) 3934 MHz·km when the first wavelength is 850 nm and the first wavelength is provided by a laser having an RMS line width of 0.60 nm or less, (c) 3761 MHz·km when the first wavelength is 857 nm and the first wavelength is provided by a laser having an RMS line width of 0.60 nm or less, or (d) 3637 MHz·km when the first wavelength is 844 nm and the first wavelength is provided by a laser having an RMS line width of 0.60 nm or less, and wherein the second effective modal bandwidth threshold is one of: (a) 3087 MHz·km when the second wavelength is 900 nm and the second wavelength is provided by a laser having an RMS line width of 0.60 nm or less, (b) 3049 MHz·km when the second wavelength is 905 nm and the second wavelength is provided by a laser having an RMS line width of 0.60 nm or less, (c) 3014 MHz·km when the second wavelength is 910 nm and the second wavelength is provided by a laser having an RMS line width of 0.60 nm or less, (d) 2981 MHz·km when the second wavelength is 915 nm and the second wavelength is provided by a laser having an RMS line width of 0.60 nm or less.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 provides a flowchart of an exemplary method 100 for selecting an optimized multimode optical fiber, according to embodiments of the present disclosure;

FIG. 2. depicts a graph of the EMB of OM3 and OM4 and OM5 MMFs vs. wavelength.

### DETAILED DESCRIPTION

Embodiments of the present disclosure are described in detail herein with reference to embodiments thereof as illustrated in the accompanying drawings, in which case reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. When a numerical value or end-point of a range does not recite “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

As used herein, “comprising” is an open-ended transitional phrase. A list of elements following the transitional phrase “comprising” is a non-exclusive list, such that elements in addition to those specifically recited in the list may also be present.

The term “or,” as used herein, is inclusive; more specifically, the phrase “A or B” means “A, B, or both A and B.” Exclusive “or” is designated herein by terms such as “either A or B” and “one of A or B,” for example.

The indefinite articles “a” and “an” to describe an element or component means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

The term “wherein” is used as an open-ended transitional phrase, to introduce a recitation of a series of characteristics of the structure.

The acronym VCSEL stands for “vertical cavity surface emitting laser.”

The terms “RMS line width”, “RMS laser line width” or “RMS line width of a laser” refer to the root-mean-square line width of the laser source (e.g. VCSEL) used to provide light at a specified wavelength or wavelength window.

The term “fiber” as used herein is shorthand for optical fiber.

The coordinate r is a radial coordinate, where r=0 corresponds to the centerline of the fiber.

The symbol “μm” is used as shorthand for “micron,” which is a micrometer, i.e., 1×10⁻⁹ meter.

The symbol “nm” is used as shorthand for “nanometer,” which is 1×10⁻⁹ meter.

The limits on any ranges cited herein are inclusive and thus to lie within the range, unless otherwise specified.

The terms “comprising,” and “comprises,” e.g., “A comprises B,” is intended to include as a special case the concept of “consisting,” as in “A consists of B.”

The term “bandwidth” is denoted BW and as the term is used herein is the modal bandwidth. For purposes of this disclosure, the modal bandwidth is also the effective modal bandwidth and is also denoted EMB. The modal bandwidth is the capacity of an optical fiber measured in MHz·km or GHz·km. It is also noted that modal bandwidth is related to and exhibited by the differential mode delay (DMD) of a fiber. Actually, the EMB as defined by the standard is measured through the DMD measurement with calculations to obtain the EMB. When multiple modes of light travel through a multimode fiber, lower order modes travel through the fiber near its center core, while higher order modes travel closer to the outside edge of the core. As is known in the art, lower and higher order modes can travel at different velocities within the fiber, and the DMD is the difference in travel time between the different modes. The smaller the DMD, the less the light spreads out from the fiber and the higher the modal bandwidth. The EMB of a multimode fiber can be measured and calculated using the following standards: FOTP-220 (TIA-455-220-A), “Differential Mode Delay Measurement of Multimode Fiber in the Time Domain” (January 2003) and IEC 60793-1-41 Ed. 3.0: Optical fibers: Part 1-41: Measurement methods and test procedures—Bandwidth.

As used herein, “link bandwidth” is the overall bandwidth (i.e., effective system bandwidth), incorporating contributions from modal bandwidth and chromatic dispersion effects.

Chromatic dispersion is the sum of the material dispersion, waveguide dispersion, and inter-modal dispersion of the fiber. In the case of a single mode waveguide fiber, the inter-modal dispersion is zero. The zero dispersion wavelength (λ₀) is the wavelength at which the dispersion has a value of zero. Chromatic dispersion slope is the rate of change of the dispersion with respect to wavelength. Chromatic dispersion and dispersion slope are expressed in units of ps/(nm·km) and ps/(nm²·km), respectively.

The bandwidth contribution from the fiber is called fiber link bandwidth. Fiber link bandwidth (BW_{eff}) includes the contributions from both modal bandwidths, (i.e., EMB and chromatic dispersion). With 0.60 nm laser linewidth, the required EMB at a specific wavelength can be calculated. The optical bandwidth at the link level can be calculated using the following equations

BW_{eff}=(EMB⁻²+BW_{CD}⁻²)^{1/2} (1)

BW_{CD}=(1.87×10⁵/U_{w})×(D²+E²)^{-1/2} (2)

D=(λ/4)×S₀(1−(U₀/λ)⁴) (3)

E=0.7×S₀×U_{w} (4)

where λ is the center wavelength of the optical fiber; and U_{w} is the rms spectral width of the optical fiber, set to 0.60 nm. Chromatic Dispersion vs. wavelength is described by the equation (4) where S₀=0.093477 ps/(nm²·km) and U₀=1328 nm. The link bandwidth (BW_{eff}) in Eq. (1) is the optical bandwidth specified at 3dBo level. In the electric domain, the bandwidth is specified at 3dBe level, in which case the conversion is: Effective Bandwidth (dBe)=Effective Bandwidth (dBo)*0.73, based on 4th order Bessel-Thomson Filter type of frequency roll-off.

Link bandwidth values can be calculated over the wavelengths from 840 nm to 860 nm. The wavelength that has the lowest link bandwidth is at 840 nm. The 3dBe link bandwidth for 25Gbaud applications is 16.3 GHz. Based on this, a calculated EMB threshold is determined at a wavelength of about 850 nm to meet a transmission distance of 80 meters, 90 meters and 100 meters. With the information of target fiber transmission distance L, which can be 80 meters, 85 meters, 90 meters, or 100 meters, the EMB needed at a specific individual wavelength can be calculated using the equation,

$$E M B = \frac{1}{\sqrt{\frac{1}{{BW}_{eff}^{2} \cdot {L}^{2}} - \frac{1}{{BW}_{C D}^{2}}}} \qquad ( 5 )$$

Multimode optical fibers can be produced to have a bandwidth BW exceeding a bandwidth threshold at a specified wavelength at which a VCSEL operates. In some embodiments, a VSCEL operates at a specified wavelength of 850 nm. In some embodiments, a VSCEL operates at a specified wavelength of 910 nm. In some embodiments, a VSCEL operates at a specified wavelength of 915 nm. In some embodiments, reference to a VSCEL operational wavelength of 850 nm refers to a wavelength range of 844 nm to 863 nm. For example, for 100G/lane based VCSEL transceivers, reference to an operational wavelength of 850 nm refers to a wavelength range of 844 nm to 863 nm. In some embodiments, reference to a VSCEL operational wavelength of 850 nm refers to a wavelength range of 840 nm to 860 nm. For example, for 25Gbaud based VCSEL transceivers, including but not limited to 25G SR and 100G SR4, a VSCEL operational wavelength of 850 nm refers to a wavelength range of 840 nm to 860 nm. In some embodiments, reference to a VSCEL operational wavelength of 910 nm or 915 nm refers to a wavelength range of 900 nm to 915 nm or 900 nm to 916 nm. For example, for an 800G BiDi VCSEL transceiver application, reference to an operational wavelength of 910 nm wavelength or an operational wavelength of 915 nm refers to a wavelength range of 900 nm to 915 nm or 900 nm to 916 nm.

An OM4-grade multimode optical fiber is defined to have an EMB of at least 4700 MHz·km at 850 nm. An OM5-grade multimode optical fiber must further have an EMB of at least 2470 MHz·km at 953 nm. The modal bandwidth of multimode optical fibers is wavelength dependent and is generally peaked at a certain wavelength gyp. Due to material dispersion, the peak modal bandwidth of multimode optical fibers decreases from this peak value when the wavelength moves away from the peak wavelength. The wavelength dependence of OM3 and OM4 and OM5 are shown in FIG. 2. As recited above, the 850 nm wavelength for 25Gbaud transceivers refers to a wavelength range of 840 nm to 860 nm, while the 850 nm wavelength for 100G/lane transceivers refers to a wavelength range of 844 nm to 863 nm in some situations and a wavelength range of 842 nm to 868 nm in other situations. As depicted in FIG. 2, the minimum EMB of an optical fiber needed to meet a transmission distance decreases from 850 nm either when the wavelength increases or decreases. For OM4 the slope of the decrease is steeper than the slope of the decrease for OM3. For an optical fiber with an EMB at 850 nm that falls between the EMB for OM3 and the EMB for OM4 at 850 nm (i.e between 2000 MHz·km and 4700 MHz·km) linear interpretation is used to determine the EMB value at 850 nm from the EMB value at 840 nm for 25Gbaud transceivers or the EMB value at 863 nm for 100G/lane transceivers. Accordingly, when such calculated EMB value is met by an optical fiber at a wavelength of 850 nm, the EMB at the full 850 nm wavelength range (i.e. 840 nm to 860 nm for 25Gbaud transceivers or 844 nm to 863 nm for 100G/lane transceivers) meets (i.e. is equal to or greater than) the required EMB values for each wavelength in the wavelength range

Multimode transceivers that couple one wavelength or multiple wavelengths into a single multimode optical fiber include 25Gbaud MM VCSEL, 100G BiDi, 400G SR8, 400G SR4.2, and 100G/lane based transceivers, such as 800G SR8, 800G BiDi. These transceivers each utilize one or more wavelengths including 850 nm and/or 910 nm. For example, 25G SR, 100G SR4, 400G SR8 transceivers have an operating wavelength at 850 nm only, while 100G BiDi, 400G SR4.2 and 800G BiDi transceivers have an operating wavelength at 850 nm and at 910 or 915 nm wavelength windows.

Transceivers also operate with a specification for their RMS laser line width. For 100G/lane-based transceivers, including 400G SR4, 400G SR4.2 and 800G BiDi etc, a commonly used laser RMS line width is 0.60 nm. But other slightly different values of the laser RMS line width are also used, such as 0.65 nm or 0.58 nm. In the application, we will clearly state the RMS laser line width assumption associated with each EMB specified.

Aspects of the present disclosure are directed to categorizing and selecting from a group or set of like multimode optical fibers (e.g., fibers belonging to a select OM-standard) those multimode optical fibers that meet bandwidth requirements based upon first and second wavelengths.

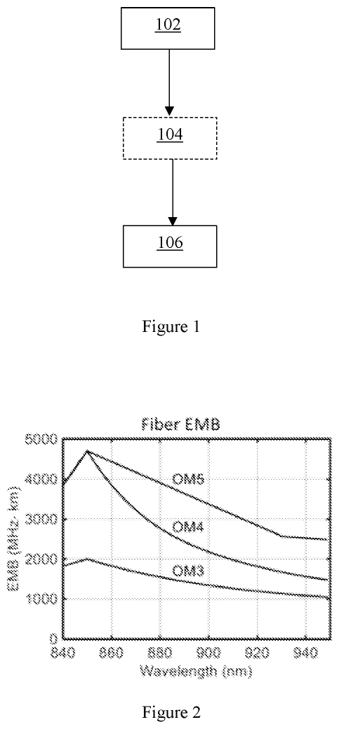

Process 100 of FIG. 1 provides a flow chart of an exemplary process disclosed herein, which categorizes and creates a subset of optimized fibers from a group of like multimode optical fibers. At step 102, a first effective modal bandwidth at a first wavelength of each fiber in a group of like multimode optical fibers meeting a first OM standard (e.g., a group of OM3 fibers or a group of OM4 fibers) is compared with a first effective modal bandwidth threshold. In embodiments, at step 106, fibers with an effective modal bandwidth at the first wavelength, below the first threshold may be categorized as “fail” fibers and fibers with an effective modal bandwidth at the first wavelength equal to or greater than the first threshold are categorized as “pass” fibers (i.e., fibers that may be utilized for a transmission distance defined in a transceiver specification).

In an exemplary embodiment, an optical fiber having a first effective modal bandwidth that is greater than or equal to a first effective modal bandwidth threshold of 2310 MHz·km at the first wavelength of 850 nm is categorized as an optical fiber that may be utilized for a transmission distance of 70 meters. In an exemplary embodiment utilizing 100G/lane transceivers, the first wavelength of 850 nm refers to a wavelength range of 844 nm to 863 nm. The RMS laser line width of the laser in this wavelength window is 0.60 nm or less in this embodiment.

In an exemplary embodiment, an optical fiber having a first effective modal bandwidth that is greater than or equal to a first effective modal bandwidth threshold of 2890 MHz·km at the first wavelength of 850 nm is categorized as an optical fiber that may be utilized for a transmission distance of 80 meters. In an exemplary embodiment utilizing 100G/lane transceivers, the first wavelength of 850 nm refers to a wavelength range of 844 nm to 863 nm. The RMS laser line width of the laser in this wavelength window is 0.60 nm or less in this embodiment.

In an exemplary embodiment, an optical fiber having a first effective modal bandwidth that is greater than or equal to a first effective modal bandwidth threshold of 2890 MHz·km at the first wavelength of 850 nm is categorized as an optical fiber that may be utilized for a transmission distance of greater than or equal to 100 meters, such as 122 meters. In an exemplary embodiment utilizing 50G PAM4 transceivers such as in 400G SR4.2, the first wavelength of 850 nm refers to a wavelength range of 840 nm to 860 nm. The RMS laser line width of the laser in this wavelength window is 0.60 nm or less in this embodiment.

In an exemplary embodiment, an optical fiber having a first effective modal bandwidth that is greater than or equal to a first effective modal bandwidth threshold of 3240 MHz·km at the first wavelength of 850 nm is categorized as an optical fiber that may be utilized for a transmission distance of 85 meters. In an exemplary embodiment utilizing 100G/lane transceivers, the first wavelength of 850 nm refers to a wavelength range of 844 nm to 863 nm. The RMS laser line width of the laser in this wavelength window is 0.60 nm or less in this embodiment.

In an exemplary embodiment, an optical fiber having a first effective modal bandwidth that is greater than or equal to a first effective modal bandwidth threshold of 3642 MHz·km at the first wavelength of 850 nm is categorized as an optical fiber that may be utilized for a transmission distance of 90 meters. In an exemplary embodiment utilizing 100G/lane transceivers, the first wavelength of 850 nm refers to a wavelength range of 844 nm to 863 nm. The RMS laser line width of the laser in this wavelength window is 0.60 nm or less in this embodiment.

In an exemplary embodiment, an optical fiber having a first effective modal bandwidth that is greater than or equal to a first effective modal bandwidth threshold of 4700 MHz·km at the first wavelength of 850 nm is categorized as an optical fiber that may be utilized for a transmission distance of 100 meters. In an exemplary embodiment utilizing 100G/lane transceivers, the first wavelength of 850 nm refers to a wavelength range of 844 nm to 863 nm. The RMS laser line width of the laser in this wavelength window is 0.60 nm or less in this embodiment.

In embodiments, including but not limited to embodiments utilizing 50G PAM4 transceivers such as in 400G SR4.2, an optical fiber having a first effective modal bandwidth that is greater than or equal to a first effective modal bandwidth threshold of 4700 MHz·km at the first wavelength of 850 nm is categorized as an optical fiber that may be utilized for a transmission distance that is greater than or equal to 150 meters. In an exemplary embodiment utilizing 50G PAM4 transceivers such as in 400G SR4.2, the first wavelength of 850 nm refers to a wavelength range of 844 nm to 863 nm. The RMS laser line width of the laser in this wavelength window is 0.60 nm or less in this embodiment.

In some embodiments, at step 104, a second effective modal bandwidth at a second wavelength of each fiber in the group of like multimode optical fibers is compared with a second effective modal bandwidth threshold. In embodiments where the second effective modal bandwidth of an optical fiber is compared with a second effective modal bandwidth threshold, at step 106, an optical fiber with a first effective modal bandwidth at the first wavelength, below the first threshold and a second effective modal bandwidth at the second wavelength, below the second threshold may be categorized “fail” fibers while fibers with a first effective modal bandwidth at the first wavelength equal to or greater than the first threshold and a second effective modal bandwidth at the second wavelength equal to or greater than the second threshold are categorized as “pass” fibers (i.e. fibers that may be utilized for a transmission distance defined in a transceiver specification).

In an exemplary embodiment, an optical fiber having a first effective modal bandwidth that is greater than or equal to a first effective modal bandwidth threshold of 2310 MHz·km at the first wavelength of 850 nm and a second effective modal bandwidth that is greater than or equal to a second effective modal bandwidth threshold of 1898 MHz·km at the second wavelength of 910 nm or greater than or equal to a second effective modal bandwidth threshold of 1890 MHz·km at the second wavelength of 915 nm is categorized as an optical fiber that may be utilized for a transmission distance of 70 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser in both the wavelength windows around 850 nm and 910 nm is 0.60 nm or less in this embodiment.

In an exemplary embodiment, an optical fiber having a first effective modal bandwidth that is greater than or equal to a first effective modal bandwidth threshold of 2890 MHz·km at the first wavelength of 850 nm and a second effective modal bandwidth that is greater than or equal to a second effective modal bandwidth threshold of 2243 MHz·km at the second wavelength of 910 nm or greater than or equal to a second effective modal bandwidth threshold of 2228 MHz·km at the second wavelength of 915 nm is categorized as an optical fiber that may be utilized for a transmission distance of 80 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser in both the wavelength windows around 850 nm and 910 nm is 0.60 nm or less in this embodiment.

In an exemplary embodiment, an optical fiber having a first effective modal bandwidth that is greater than or equal to a first effective modal bandwidth threshold of 3240 MHz·km at the first wavelength of 850 nm and a second effective modal bandwidth that is greater than or equal to a second effective modal bandwidth threshold of 2429 MHz·km at the second wavelength of 910 nm or greater than or equal to a second effective modal bandwidth threshold of 2411 MHz·km at the second wavelength of 915 nm is categorized as an optical fiber that may be utilized for a transmission distance of 85 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser in both the wavelength windows around 850 nm and 910 nm is 0.60 nm or less in this embodiment.

In an exemplary embodiment, an optical fiber having a first effective modal bandwidth that is greater than or equal to a first effective modal bandwidth threshold of 3640 MHz·km at the first wavelength of 850 nm and a second effective modal bandwidth that is greater than or equal to a second effective modal bandwidth threshold of 2627 MHz·km at the second wavelength of 910 nm or greater than or equal to a second effective modal bandwidth threshold of 2604 MHz·km at the second wavelength of 915 nm is categorized as an optical fiber that may be utilized for a transmission distance of 90 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser in both the wavelength windows around 850 nm and 910 nm is 0.60 nm or less in this embodiment.

In an exemplary embodiment, an optical fiber having a first effective modal bandwidth that is greater than or equal to a first effective modal bandwidth threshold of 4700 MHz·km at the first wavelength of 850 nm and a second effective modal bandwidth that is greater than or equal to a second effective modal bandwidth threshold of 3067 MHz·km at the second wavelength of 910 nm or greater than or equal to a second effective modal bandwidth threshold of 3031 MHz·km at the second wavelength of 915 nm is categorized as an optical fiber that may be utilized for a transmission distance of 100 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser in both the wavelength windows around 850 nm and 910 nm is 0.60 nm or less in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2083.8 MHz·km at the first wavelength of 844 nm, (b) 2059.3 MHz·km at the first wavelength of 850 nm (c) 2033 MHz·km at the first wavelength of 857 nm, or (d) 2013 MHz·km at the first wavelength of 863 nm, and the second effective modal bandwidth threshold is one of: (a) 1917.6 MHz·km at the second wavelength of 900 nm, (b) 1907.7 MHz·km at the second wavelength of 905 nm, (c) 1898.4 MHz·km at the second wavelength of 910 nm, (d) 1889.6 MHz·km at the second wavelength of 915 nm, is categorized as an optical fiber that may be utilized for a transmission distance of 70 meters. The RMS laser line width of the laser in both the wavelength windows around 850 nm and 910 nm is 0.60 nm or less in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2568.2 MHz·km at the first wavelength of 844 nm, (b) 2522.7 MHz·km at the first wavelength of 850 nm (c) 2475.4 MHz·km at the first wavelength of 857 nm, or (d) 2438.9 MHz·km at the first wavelength of 863 nm, and wherein the second effective modal bandwidth threshold is one of: (a) 2274.6 MHz·km at the second wavelength of 900 nm, (b) 2258.2 MHz·km at the second wavelength of 905 nm, (c) 2242.8 MHz·km at the second wavelength of 910 nm, (d) 2228.4 MHz·km at the second wavelength of 915 nm, is categorized as an optical fiber that may be utilized for a transmission distance of 80 meters. The RMS laser line width of the laser in both the wavelength windows around 850 nm and 910 nm is 0.60 nm or less in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2860 MHz·km at the first wavelength of 844 nm, (b) 2797 MHz·km at the first wavelength of 850 nm (c) 2733 MHz·km at the first wavelength of 857 nm, or (d) 2684 MHz·km at the first wavelength of 863 nm, and wherein the second effective modal bandwidth threshold is one of: (a) 2470 MHz·km at the second wavelength of 900 nm, (b) 2449 MHz·km at the second wavelength of 905 nm, (c) 2429 MHz·km at the second wavelength of 910 nm, (d) 2411 MHz·km at the second wavelength of 915 nm, is categorized as an optical fiber that may be utilized for a transmission distance of 85 meters. The RMS laser line width of the laser in both the wavelength windows around 850 nm and 910 nm is 0.60 nm or less in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 3199.5 MHz·km at the first wavelength of 844 nm, (b) 3112.94 MHz·km at the first wavelength of 850 nm (c) 3025.2 MHz·km at the first wavelength of 857 nm, or (d) 2959.48 MHz·km at the first wavelength of 863 nm, and wherein the second effective modal bandwidth threshold is one of: (a) 2679 MHz·km at the second wavelength of 900 nm, (b) 2652 MHz·km at the second wavelength of 905 nm, (c) 2627 MHz·km at the second wavelength of 910 nm, (d) 2604 MHz·km at the second wavelength of 915 nm, is categorized as an optical fiber that may be utilized for a transmission distance of 90 meters. The RMS laser line width of the laser in both the wavelength windows around 850 nm and 910 nm is 0.60 nm or less in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 4113 MHz·km at the first wavelength of 844 nm, (b) 3934 MHz·km at the first wavelength of 850 nm (c) 3761 MHz·km at the first wavelength of 857 nm, or (d) 3637 MHz·km at the first wavelength of 863 nm, and wherein the second effective modal bandwidth threshold is one of: (a) 3150 MHz·km at the second wavelength of 900 nm, (b) 3107 MHz·km at the second wavelength of 905 nm, (c) 3067 MHz·km at the second wavelength of 910 nm, (d) 3031 MHz·km at the second wavelength of 915 nm is categorized as an optical fiber that may be utilized for a transmission distance of 100 meters. The RMS laser line width of the laser in both the wavelength windows around 850 nm and 910 nm is 0.60 nm or less in this embodiment.

In an exemplary embodiment, an optical fiber having a first effective modal bandwidth that is greater than or equal to a first effective modal bandwidth threshold of 2310 MHz·km at the first wavelength of 850 nm and a second effective modal bandwidth that is greater than or equal to a second effective modal bandwidth threshold of 1890 MHz·km at the second wavelength of 910 nm is categorized as an optical fiber that may be utilized for a transmission distance of 70 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.58 nm or less around 910 nm in this embodiment.

In an exemplary embodiment, an optical fiber having a first effective modal bandwidth that is greater than or equal to a first effective modal bandwidth threshold of 2890 MHz·km at the first wavelength of 850 nm and a second effective modal bandwidth that is greater than or equal to a second effective modal bandwidth threshold of 2220 MHz·km at the second wavelength of 910 nm is categorized as an optical fiber that may be utilized for a transmission distance of 80 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.58 nm or less around 910 nm in this embodiment.

In embodiments, including but not limited to embodiments utilizing 50G PAM4 transceivers such as in 400G SR4.2, an optical fiber having a first effective modal bandwidth that is greater than or equal to a first effective modal bandwidth threshold of 2890 MHz·km at the first wavelength of 850 nm and a second effective modal bandwidth that is greater than or equal to a second effective modal bandwidth threshold of 2220 MHz·km at the second wavelength of 910 nm is categorized as an optical fiber that may be utilized for a transmission distance that is greater than or equal to 100 meters, such as 122 meters. In an exemplary embodiment utilizing 50G PAM4 transceivers such as in 400G SR4.2, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.60 nm or less around 910 nm in this embodiment.

In an exemplary embodiment, an optical fiber having a first effective modal bandwidth that is greater than or equal to a first effective modal bandwidth threshold of 3240 MHz·km at the first wavelength of 850 nm and a second effective modal bandwidth that is greater than or equal to a second effective modal bandwidth threshold of 2400 MHz·km at the second wavelength of 910 nm is categorized as an optical fiber that may be utilized for a transmission distance of 85 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.58 nm or less around 910 nm in this embodiment.

In an exemplary embodiment, an optical fiber having a first effective modal bandwidth that is greater than or equal to a first effective modal bandwidth threshold of 3640 MHz·km at the first wavelength of 850 nm and a second effective modal bandwidth that is greater than or equal to a second effective modal bandwidth threshold of 2600 MHz·km at the second wavelength of 910 nm is categorized as an optical fiber that may be utilized for a transmission distance of 90 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.58 nm or less around 910 nm in this embodiment.

In an exemplary embodiment, an optical fiber having a first effective modal bandwidth that is greater than or equal to a first effective modal bandwidth threshold of 4700 MHz·km at the first wavelength of 850 nm and a second effective modal bandwidth that is greater than or equal to a second effective modal bandwidth threshold of 3010 MHz·km at the second wavelength of 910 nm is categorized as an optical fiber that may be utilized for a transmission distance of 100 meters. In an exemplary embodiment utilizing an 800G BiDi VCSEL transceiver application, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.58 nm or less around 910 nm in this embodiment. In an alternative situation for this embodiment, the second effective model bandwidth threshold is 3100 MHz·km at the second wavelength of 910 nm so that the value is the same as OM5 fiber at this wavelength.

In embodiments, including but not limited to embodiments utilizing 50G PAM4 transceivers such as in 400G SR4.2, an optical fiber having a first effective modal bandwidth that is greater than or equal to a first effective modal bandwidth threshold of 4700 MHz·km at the first wavelength of 850 nm and a second effective modal bandwidth that is greater than or equal to a second effective modal bandwidth threshold of 3010 MHz·km at the second wavelength of 910 nm is categorized as an optical fiber that may be utilized for a transmission distance that is greater than or equal to 150 meters. In an exemplary embodiment utilizing 50G PAM4 transceivers such as in 400G SR4.2, the first wavelength of 850 nm refers to a wavelength range of 844 nm to 863 nm and the second wavelength of 910 nm or 915 nm refers to a wavelength range of 900 nm to 915 nm. The RMS laser line width of the laser is 0.60 nm or less around 850 nm and 0.60 nm or less around 910 nm in this embodiment. In an alternative situation for this embodiment, the second effective model bandwidth threshold is 3100 MHz·km at the second wavelength of 910 nm so that the value is the same as OM5 fiber at this wavelength.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2084 MHz·km at the first wavelength of 844 nm, (b) 2059 MHz·km at the first wavelength of 850 nm (c) 2033 MHz·km at the first wavelength of 857 nm, or (d) 2013 MHz·km at the first wavelength of 863 nm, and the second effective modal bandwidth threshold is one of: (a) 1903 MHz·km at the second wavelength of 900 nm, (b) 1894 MHz·km at the second wavelength of 905 nm, (c) 1886 MHz·km at the second wavelength of 910 nm, (d) 1877 MHz·km at the second wavelength of 915 nm, is categorized as an optical fiber that may be utilized for a transmission distance of 70 meters. The RMS laser line width of the laser is 0.60 nm or less around 850 nm and 0.58 nm or less around 910 nm in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2568 MHz·km at the first wavelength of 844 nm, (b) 2523 MHz·km at the first wavelength of 850 nm (c) 2475 MHz·km at the first wavelength of 857 nm, or (d) 2439 MHz·km at the first wavelength of 863 nm, and wherein the second effective modal bandwidth threshold is one of: (a) 2250 MHz·km at the second wavelength of 900 nm, (b) 2236 MHz·km at the second wavelength of 905 nm, (c) 2222 MHz·km at the second wavelength of 910 nm, (d) 2208 MHz·km at the second wavelength of 915 nm, is categorized as an optical fiber that may be utilized for a transmission distance of 80 meters. The RMS laser line width of the laser is 0.60 nm or less around 850 nm and 0.58 nm or less around 910 nm in this embodiment.

In embodiments, including but not limited to embodiments utilizing 50G PAM4 transceivers such as in 400G SR4.2, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2568 MHz·km at the first wavelength of 844 nm, (b) 2523 MHz·km at the first wavelength of 850 nm (c) 2475 MHz·km at the first wavelength of 857 nm, or (d) 2439 MHz·km at the first wavelength of 863 nm, and wherein the second effective modal bandwidth threshold is one of: (a) 2250 MHz·km at the second wavelength of 900 nm, (b) 2236 MHz·km at the second wavelength of 905 nm, (c) 2222 MHz·km at the second wavelength of 910 nm, (d) 2208 MHz·km at the second wavelength of 915 nm, is categorized as an optical fiber that may be utilized for a transmission distance that is greater than or equal to 100 meters, such as 122 meters. The RMS laser line width of the laser is 0.60 nm or less around 850 nm and 0.60 nm or less around 910 nm in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 2860 MHz·km at the first wavelength of 844 nm, (b) 2797 MHz·km at the first wavelength of 850 nm (c) 2733 MHz·km at the first wavelength of 857 nm, or (d) 2684 MHz·km at the first wavelength of 863 nm, and wherein the second effective modal bandwidth threshold is one of: (a) 2439 MHz·km at the second wavelength of 900 nm, (b) 2420 MHz·km at the second wavelength of 905 nm, (c) 2402 MHz·km at the second wavelength of 910 nm, (d) 2386 MHz·km at the second wavelength of 915 nm, is categorized as an optical fiber that may be utilized for a transmission distance of 85 meters. The RMS laser line width of the laser is 0.60 nm or less around 850 nm and 0.58 nm or less around 910 nm in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 3200 MHz·km at the first wavelength of 844 nm, (b) 3113 MHz·km at the first wavelength of 850 nm (c) 3025 MHz·km at the first wavelength of 857 nm, or (d) 2959 MHz·km at the first wavelength of 863 nm, and wherein the second effective modal bandwidth threshold is one of: (a) 2640 MHz·km at the second wavelength of 900 nm, (b) 2616 MHz·km at the second wavelength of 905 nm, (c) 2593 MHz·km at the second wavelength of 910 nm, (d) 2573 MHz·km at the second wavelength of 915 nm, is categorized as an optical fiber that may be utilized for a transmission distance of 90 meters. The RMS laser line width of the laser is 0.60 nm or less around 850 nm and 0.58 nm or less around 910 nm in this embodiment.

In embodiments, including but not limited to embodiments utilizing 100G/lane transceivers, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 4113 MHz·km at the first wavelength of 844 nm, (b) 3934 MHz·km at the first wavelength of 850 nm (c) 3761 MHz·km at the first wavelength of 857 nm, or (d) 3637 MHz·km at the first wavelength of 863 nm, and wherein the second effective modal bandwidth threshold is one of: (a) 3087 MHz·km at the second wavelength of 900 nm, (b) 3049 MHz·km at the second wavelength of 905 nm, (c) 3014 MHz·km at the second wavelength of 910 nm, (d) 2980 MHz·km at the second wavelength of 915 nm, is categorized as an optical fiber that may be utilized for a transmission distance of 100 meters. The RMS laser line width of the laser is 0.60 nm or less around 850 nm and 0.58 nm or less around 910 nm in this embodiment.

In embodiments, including but not limited to embodiments utilizing 50G PAM4 transceivers such as in 400G SR4.2, an optical fiber having a first effective modal bandwidth that is greater than or equal to a first effective modal bandwidth threshold and a second effective modal bandwidth that is greater than or equal to a second effective modal bandwidth threshold, wherein the first effective modal bandwidth threshold is one of: (a) 4113 MHz·km at the first wavelength of 844 nm, (b) 3934 MHz·km at the first wavelength of 850 nm (c) 3761 MHz·km at the first wavelength of 857 nm, or (d) 3637 MHz·km at the first wavelength of 863 nm, and wherein the second effective modal bandwidth threshold is one of: (a) 3087 MHz·km at the second wavelength of 900 nm, (b) 3049 MHz·km at the second wavelength of 905 nm, (c) 3014 MHz·km at the second wavelength of 910 nm, (d) 2980 MHz·km at the second wavelength of 915 nm, is categorized as an optical fiber that may be utilized for a transmission distance that is greater than or equal to 150 meters. The RMS laser line width of the laser is 0.60 nm or less around 850 nm and 0.60 nm or less around 910 nm in this embodiment.

The above embodiments can be used for a number of applications. One exemplary application is for 400G SR4, which operates at 850 nm only. Another exemplary application is for 800G BiDi which operates at both 850 nm and 910 nm wavelength windows. The same 800G BiDi transceiver specifications will carry on and be applied to 1.6 T BiDi transceivers. The fiber selection methods above have been applied to the SR type of applications which has tighter laser line width. In parallel to the SR applications, there is a category of applications, called VR. They have slightly wider wavelength windows and slightly wider laser line width and therefore have shorter transmission reaches. For SR applications, the fiber link bandwidth is specified to be 18.0 GHz while for VR applications, the fiber link bandwidth is specified to be 25.1 GHz. For a person skilled in the art, one can follow the same principle in the current document to define system reach longer than the general OM3 and OM4. Also, for the skilled person in the art, one can figure out the system reach for the fiber defined in the current application to VR type of transceivers. For example, the fiber defined for 100 m reach can have reach of 68 m for VR 800G BiDi transceivers. The fiber defined for 80 m reach can have reach of 55 m for VR 800G BiDi transceivers.

The optical fibers described herein can be used for 100G/lane transmission for either transceiver operating at 850 nm wavelength window only, such as in 400G SR application, or using both 850 nm and 910 nm wavelength windows, such as for 800G BiDi applications. As also described above, the optical fibers described herein also bring benefits for 50G PAM4 based transmission using VCSEL based transceivers, which is half of the data rate of 100G/lane. One type of optical transceivers based on 50G PAM4 transmission is called 400G SR4.2. It transmits over 850 nm and 910 nm wavelength windows using 8 fibers. 100G BiDi transceiver is based on the same optical specifications as 400G SR4.2 by using 850 nm and/or 910 nm wavelengths using 2 fibers and 50G PAM4 modulation. The transmission reaches are defined as 70 m over OM3, 100 m over OM4 and 150 nm over OM5 multimode fibers. The 400G SR4.2 transceivers are defined in IEEE 802.3 cm. The 850 nm wavelength window includes the wavelengths from 844 to 863 nm. The 910 nm wavelength window includes the wavelengths from 900 nm to 918 nm. The lowest or limiting link bandwidth for this application is defined by 150 nm OM5 transmission at 918 nm, with 3dBe link bandwidth of 11.66 GHz, which is far lower than the 18 GHz used for 100G/lane transmission. Accordingly, using the optical fibers described herein for 100G/lane applications, for 50G PAM4 based transmission, the system reach can be much longer. For example, for the fibers defined in paragraphs [0080], [0098], and [0105], respectively, for 80 meters 100G/lane transmission, using 50G PAM4 based transmission such as in 400G SR4.2, the transmission distance or reach is at least 100 meters, such as 122 meters, as described in paragraphs [0081], [0099], and [0106], respectively. For the optical fibers defined in paragraph [0084], [0102], and [0109], respectively, for 100G/lane transmission, the transmission distance or reach can be over 150 m as described in paragraphs [0085], [0103], and [0110], respectively, while meeting the 11.6 GHz link bandwidth requirements in 50G PAM4 transmission.

In some embodiments, a subset of OM3 fibers that meet distance specifications using a 25Gbaud MM VCSEL based transceiver can be selected by comparing a first effective modal bandwidth of a multimode optical fiber at a first wavelength with a first effective modal bandwidth threshold at the first wavelength, the multimode optical fiber being in a group of multimode optical fibers meeting a first OM standard. In embodiments, fibers with an effective modal bandwidth at the first wavelength, below the first threshold may be considered “fail” fibers. Fibers with an effective modal bandwidth at the first wavelength equal to or greater than the first threshold are categorized as “pass” fibers (i.e. fibers that may be utilized for a transmission distance defined in a transceiver specification). For 25Gbaud VCSEL transceivers, a VSCEL operational wavelength of 850 nm refers to a wavelength range of 840 nm to 860 nm. The transmission distance transceiver specification for 25Gbaud VCSEL transceivers has been specified by the Institute of Electrical and Electronics Engineers (IEEE) at 70 meters for OM3 and at 100 meters for OM4. The laser (VCSEL) RMS line width is specified as 0.60 nm or less. For example, using a target transmission distance of 80 meters, and wavelengths of 840 nm, 845 nm, 850 nm, 855 nm and 860 nm, and laser linewidth and chromatic dispersion values listed above, EMB values in Table 3 below can be calculated:

TABLE 3

| Wavelength (nm) | EMB (MHz · km) |
|---|---|
| 840 | 2214 |
| 845 | 2188 |
| 850 | 2165 |
| 855 | 2143 |
| 860 | 2123 |

The EMB values shown in Table 3 are the individual values needed at the specific wavelengths to meet the 16.3 GHz link bandwidth requirements. As noted above in paragraph [0074], the EMB for OM3 or OM4 would fall from the 850 nm wavelength either when increasing the wavelength or decreasing the wavelength (See also FIG. 2), therefore in some embodiment, an EMB value at 850 nm is specified so that over the full wavelength range of 840 nm to 860 nm, once said EMB value at 850 nm is met, the EMB values over the full 840 nm to 860 nm range would also be met. As a result, the 850 nm EMB needed for 25GBaud applications to meet 80 meter, 85 meter, 90 meter and 100 meter transmission reaches are: 2480 MHz·km, 2766 MHz·km, 3094 MHz·km, and 3940 MHz·km respectively.

In an exemplary embodiment, an optical fiber having a first effective modal bandwidth that is greater than or equal to a first effective modal bandwidth threshold of 2480 MHz·km at the first wavelength of 850 nm is categorized as an optical fiber that may be utilized for a transmission distance of 80 meters. In an exemplary embodiment utilizing 25Gbaud VCSEL transceivers, the first wavelength of 850 nm refers to a wavelength range of 840 nm to 860 nm. In embodiments using a 25Gbaud MM VCSEL based transceiver, an optical fiber having a first effective modal bandwidth that is greater than or equal to a first effective modal bandwidth threshold is categorized as an optical fiber that may be utilized for a transmission distance of 80 meters, wherein the first effective modal bandwidth threshold is one of: (a) 2214 MHz·km at the first wavelength of 840 nm, (b) 2188 MHz·km at the first wavelength of 845 nm, (c) 2165 MHz·km at the first wavelength of 850 nm, (d) 2143 MHz·km at the first wavelength of 855 nm, or (e) 2123 MHz·km at the first wavelength of 860 nm.

In an exemplary embodiment, an optical fiber having a first effective modal bandwidth that is greater than or equal to a first effective modal bandwidth threshold of 2766 MHz·km at the first wavelength of 850 nm is categorized as an optical fiber that may be utilized for a transmission distance of 85 meters. In an exemplary embodiment utilizing 25Gbaud VCSEL transceivers, the first wavelength of 850 nm refers to a wavelength range of 840 nm to 860 nm. In embodiments using a 25Gbaud MM VCSEL based transceiver, an optical fiber having a first effective modal bandwidth that is greater than or equal to a first effective modal bandwidth threshold is categorized as an optical fiber that may be utilized for a transmission distance of 80 meters, wherein the first effective modal bandwidth threshold is one of: (a) 2438 MHz·km at the first wavelength of 840 nm, (b) 2404 MHz·km at the first wavelength of 845 nm, (c) 2373 MHz·km at the first wavelength of 850 nm, (d) 2344 MHz·km at the first wavelength of 855 nm, or (e) 2318 MHz·km at the first wavelength of 860 nm.

In an exemplary embodiment, an optical fiber having a first effective modal bandwidth that is greater than or equal to a first effective modal bandwidth threshold of 3094 MHz·km at the first wavelength of 850 nm is categorized as an optical fiber that may be utilized for a transmission distance of 90 meters. In an exemplary embodiment utilizing 25Gbaud VCSEL transceivers, the first wavelength of 850 nm refers to a wavelength range of 840 nm to 860 nm. In embodiments using a 25Gbaud MM VCSEL based transceiver, an optical fiber having a first effective modal bandwidth that is greater than or equal to a first effective modal bandwidth threshold is categorized as an optical fiber that may be utilized for a transmission distance of 90 meters, wherein and the first effective modal bandwidth threshold is one of: (a) 2689 MHz·km at the first wavelength of 840 nm, (b) 2644 MHz·km at the first wavelength of 845 nm, (c) 2603 MHz·km at the first wavelength of 850 nm, (d) 2565 MHz·km at the first wavelength of 855 nm, or (e) 2530 MHz·km at the first wavelength of 860 nm.

In an exemplary embodiment, an optical fiber having a first effective modal bandwidth that is greater than or equal to a first effective modal bandwidth threshold of 3940 MHz·km at the first wavelength of 850 nm is categorized as an optical fiber that may be utilized for a transmission distance of 100 meters. In an exemplary embodiment utilizing 25Gbaud VCSEL transceivers, the first wavelength of 850 nm refers to a wavelength range of 840 nm to 860 nm. In embodiments using a 25Gbaud MM VCSEL based transceiver, an optical fiber having a first effective modal bandwidth that is greater than or equal to a first effective modal bandwidth threshold is categorized as an optical fiber that may be utilized for a transmission distance of 100 meters, wherein the first effective modal bandwidth threshold is one of: (a) 3310 MHz·km at the first wavelength of 840 nm, (b) 3227 MHz·km at the first wavelength of 845 nm, (c) 3153 MHz·km at the first wavelength of 850 nm, (d) 3086 MHz·km at the first wavelength of 855 nm, or (e) 3027 MHz·km at the first wavelength of 860 nm.

For 100G/lane VCSEL transceivers, the SR type of transceivers having longer reach, 18.0 GHz is the minimal 3dBe link bandwidth required for the fiber link to work. Fiber link bandwidth includes the contributions from both modal bandwidths, (i.e., EMB and chromatic dispersion). The wavelength range for the 850 nm windows cover from 844 nm to 863 nm. The RMS laser line width for the 850 nm window is specified as 0.60 nm or less. The wavelength with the lowest link bandwidth is at 863 nm from 100 m OM4. Based on this information, a calculated EMB threshold is determined at a wavelength of about 863 nm to meet a transmission distance of 70 meters, 80 meters, 85 meters and 90 meters. Using Eq. (5), a target transmission distance, for example, of 80 meters, and wavelengths of 844 nm, 850 nm, 857 nm and 863 nm, and laser linewidth and chromatic dispersion values listed above, the EMB values in Table 4 below are calculated:

TABLE 4

| Wavelength (nm) | EMB (MHz · km) |
|---|---|
| 844 | 2568 |
| 850 | 2523 |
| 857 | 2475 |
| 863 | 2439 |

The EMB values shown in Table 4 are the individual values needed at the specific wavelengths to meet the 18.0 GHz link bandwidth requirement. As noted above in paragraph [0074], the EMB for OM3 or OM4 would fall from the 850 nm wavelength when either increasing the wavelength or decreasing the wavelength (See also FIG. 2), therefore in some embodiment, an EMB value at 850 nm is specified so that over the full wavelength range of 844 nm to 863 nm, once said EMB value at 850 nm is met, the EMB values over the full 844 nm to 863 nm range would also be met. As a result, the 850 nm EMB needed for 25GBaud applications to meet 70 meter, 80 meter, 85 meter, 90 meter and 100 meter transmission reaches are: 2306 MHz·km, 2888 MHz·km, 3237 MHz·km, 3642 MHz·km and 4700 MHz·km respectively.

The 3dBe link bandwidth for 25Gbaud transceivers is 16.3 GHz, which is lower than the 3dBe link bandwidth for required for 100G/lane transceivers (i.e. 18.0 GHz for SR applications and 25.1 GHz for VR applications). Such 3dBe link bandwidth requirements can be specified at an 850 nm wavelength. Therefore, optical fibers that meet an 18 GHz link bandwidth requirement for 100G/lane transceivers also meet and actually exceed 16.3 GHz 3dBe link bandwidth requirements for 25Gbaud transceivers.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments but should be defined only in accordance with the following claims and their equivalents.

What is claimed is:

1. A method of selecting a group of multimode optical fibers, the method comprising
comparing a first effective modal bandwidth at a first wavelength of a multimode optical fiber with a first effective modal bandwidth threshold at the first wavelength, the multimode optical fiber being in a group of multimode optical fibers meeting a first OM standard, wherein the first wavelength is from 844 nm to 863 nm; and
categorizing the multimode optical fiber as passing a transmission distance requirement if the first effective modal bandwidth of the first multimode optical fiber is greater than or equal to the first effective modal bandwidth threshold;
wherein the transmission distance is defined in a transceiver specification, wherein the transceiver specification is one or more of: (a) an 800G bidirectional (BiDi) transceiver specification, or (b) a 100G/lane based MM VCSEL transceiver specification, or (c) a 25Gbaud based transceiver specification, or (d) 50G PAM4 based transceiver specification.

2. The method of claim 1, further comprising:
comparing a second effective modal bandwidth at a second wavelength of the multimode optical fiber with a second effective modal bandwidth threshold at the second wavelength, the multimode optical fiber being in a group of multimode optical fibers meeting the first OM standard, wherein the second wavelength is from 900 nm to 915 nm; and.
categorizing the multimode optical fiber as passing the transmission distance requirement if the first effective modal bandwidth of the first multimode optical fiber is greater than or equal to the first effective modal bandwidth threshold and the second effective modal bandwidth of the first multimode optical fiber is greater than or equal to the second effective modal bandwidth threshold.

3. The method of claim 1, wherein the first OM-standard comprises one of an OM3-standard or an OM4-standard.

4. The method of claim 1, wherein the transmission distance is greater than or equal to 70 meters, or greater than or equal to 80 meters, or greater than or equal to 85 meters, or greater than or equal to 90 meters, or greater than or equal to 100 meters, or greater than or equal to 150 meters.

5. The method of claim 1, wherein the transmission distance is 70 meters, the first wavelength is 850 nm, and the first effective modal bandwidth threshold is 2310 MHz·km when the first wavelength is provided by a laser having an RMS line width of 0.60 nm or less.

6. The method of claim 1, wherein the transmission distance is 80 meters, the first wavelength is 850 nm, and the first effective modal bandwidth threshold is 2890 MHz·km when the first wavelength is provided by a laser having an RMS line width of 0.60 nm or less.

7. The method of claim 1, wherein the transmission distance is greater than or equal to 100 meters, the first wavelength is 850 nm, and the first effective modal bandwidth threshold is 2890 MHz·km when the first wavelength is provided by a laser having an RMS line width of 0.60 nm or less.

8. The method of claim 1, wherein the transmission distance is 85 meters, the first wavelength is 850 nm, and the first effective modal bandwidth threshold is 3240 MHz·km when the first wavelength is provided by a laser having an RMS line width of 0.60 nm or less.

9. The method of claim 1, wherein the transmission distance is 90 meters, the first wavelength is 850 nm, and the first effective modal bandwidth threshold is 3640 MHz·km when the first wavelength is provided by a laser having an RMS line width of 0.60 nm or less.

10. The method of claim 2, wherein the transmission distance is 70 meters, the first wavelength is 850 nm, the second wavelength is 910 nm, the first effective modal bandwidth threshold is 2310 MHz·km when the first wavelength is provided by a laser having an RMS line width of 0.60 nm or less and the second effective modal bandwidth threshold is 1890 MHz·km when the second wavelength is provided by a laser having an RMS line width of 0.58 nm or less.

11. The method of claim 2, wherein the transmission distance is 80 meters, the first wavelength is 850 nm, the second wavelength is 910 nm, the first effective modal bandwidth threshold is 2890 MHz·km when the first wavelength is provided by a laser having an RMS line width of 0.60 nm or less and the second effective modal bandwidth threshold is 2220 MHz·km when the second wavelength is provided by a laser having an RMS line width of 0.58 nm or less.

12. The method of claim 2, wherein the transmission distance is greater than or equal to 100 meters, the first wavelength is 850 nm, the second wavelength is 910 nm, the first effective modal bandwidth threshold is 2890 MHz·km when the first wavelength is provided by a laser having an RMS line width of 0.60 nm or less and the second effective modal bandwidth threshold is 2220 MHz·km when the second wavelength is provided by a laser having an RMS line width of 0.60 nm or less.

13. The method of claim 2, wherein the transmission distance is 85 meters, the first wavelength is 850 nm, the second wavelength is 910 nm, the first effective modal bandwidth threshold is 3240 MHz·km when the first wavelength is provided by a laser having an RMS line width of 0.60 nm or less and the second effective modal bandwidth threshold is 2400 MHz·km when the second wavelength is provided by a laser having an RMS line width of 0.58 nm or less.

14. The method of claim 2, wherein the transmission distance is 90 meters, the first wavelength is 850 nm, the second wavelength is 910 nm, the first effective modal bandwidth threshold is 3640 MHz·km when the first wavelength is provided by a laser having an RMS line width of 0.60 nm or less and the second effective modal bandwidth threshold is 2600 MHz·km when the second wavelength is provided by a laser having an RMS line width of 0.58 nm or less.

15. The method of claim 2, wherein the transmission distance is 100 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3010 MHz·km when the second wavelength is provided by a laser having an RMS line width of 0.58 nm or less.

16. The method of claim 2, wherein the transmission distance is greater than or equal to 150 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3010 MHz·km when the second wavelength is provided by a laser having an RMS line width of 0.60 nm or less.

17. The method of claim 2, wherein the transmission distance is 100 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3100 MHz·km when the second wavelength is provided by a laser having an RMS line width of 0.58 nm or less.

18. The method of claim 2, wherein the transmission distance is greater than or equal to 150 meters, the first wavelength is 850 nm, the second wavelength is 910 nm, the first effective modal bandwidth threshold is 4700 MHz·km when the first wavelength is provided by a laser having an RMS line width of 0.60 nm or less and the second effective modal bandwidth threshold is 3100 MHz·km when the second wavelength is provided by a laser having an RMS line width of 0.60 nm or less.

19. The method of claim 2, wherein the transmission distance is 70 meters, wherein the first effective modal bandwidth threshold is one of: (a) 2084 MHz·km at the first wavelength of 844 nm when the first wavelength is 844 nm and the first wavelength is provided by a laser having an RMS line width of 0.60 nm or less, (b) 2059 MHz·km when the first wavelength is 850 nm and the first wavelength is provided by a laser having an RMS line width of 0.60 nm or less, (c) 2033 MHz·km when the first wavelength is 857 nm and the first wavelength is provided by a laser having an RMS line width of 0.60 nm or less, or (d) 2013 MHz·km when the first wavelength is 863 nm and the first wavelength is provided by a laser having an RMS line width of 0.60 nm or less, and wherein the second effective modal bandwidth threshold is one of: (a) 1903 MHz·km when the second wavelength is 900 nm and the second wavelength is provided by a laser having an RMS line width of 0.58 nm or less, (b) 1894 MHz·km when the second wavelength is 905 nm and the second wavelength is provided by a laser having an RMS line width of 0.58 nm or less, (c) 1886 MHz·km when the second wavelength is 910 nm and the second wavelength is provided by a laser having an RMS line width of 0.58 nm or less, (d) 1877 MHz·km when the second wavelength is 915 nm and the second wavelength is provided by a laser having an RMS line width of 0.58 nm or less.

20. The method of claim 2, wherein the transmission distance is 80 meters, wherein the first effective modal bandwidth threshold is one of: (a) 2568 MHz·km when the first wavelength is 844 nm and the first wavelength is provided by a laser having an RMS line width of 0.60 nm or less, (b) 2523 MHz·km when the first wavelength is 850 nm and the first wavelength is provided by a laser having an RMS line width of 0.60 nm or less, (c) 2475 MHz·km when the first wavelength is 857 nm and the first wavelength is provided by a laser having an RMS line width of 0.60 nm or less, or (d) 2439 MHz·km when the first wavelength is 863 nm and the first wavelength is provided by a laser having an RMS line width of 0.60 nm or less, and wherein the second effective modal bandwidth threshold is one of: (a) 2250 MHz·km when the second wavelength is 900 nm and the second wavelength is provided by a laser having an RMS line width of 0.58 nm or less, (b) 2236 MHz·km when the second wavelength is 905 nm and the second wavelength is provided by a laser having an RMS line width of 0.58 nm or less, (c) 2222 MHz·km when the second wavelength is 910 nm and the second wavelength is provided by a laser having an RMS line width of 0.58 nm or less, (d) 2208 MHz·km when the second wavelength is 915 nm and the second wavelength is provided by a laser having an RMS line width of 0.58 nm or less.

21. The method of claim 2, wherein the transmission distance is greater than or equal to 100 meters, wherein the first effective modal bandwidth threshold is one of: (a) 2568 MHz·km when the first wavelength is 844 nm and the first wavelength is provided by a laser having an RMS line width of 0.60 nm or less, (b) 2523 MHz·km when the first wavelength is 850 nm and the first wavelength is provided by a laser having an RMS line width of 0.60 nm or less, (c) 2475 MHz·km when the first wavelength is 857 nm and the first wavelength is provided by a laser having an RMS line width of 0.60 nm or less, or (d) 2439 MHz·km when the first wavelength is 863 nm and the first wavelength is provided by a laser having an RMS line width of 0.60 nm or less, and wherein the second effective modal bandwidth threshold is one of: (a) 2250 MHz·km when the second wavelength is 900 nm and the second wavelength is provided by a laser having an RMS line width of 0.60 nm or less, (b) 2236 MHz·km when the second wavelength is 905 nm and the second wavelength is provided by a laser having an RMS line width of 0.60 nm or less, (c) 2222 MHz·km when the second wavelength is 910 nm and the second wavelength is provided by a laser having an RMS line width of 0.60 nm or less, (d) 2208 MHz·km when the second wavelength is 915 nm and the second wavelength is provided by a laser having an RMS line width of 0.60 nm or less.

22. The method of claim 2, wherein the transmission distance is 85 meters, the first effective modal bandwidth threshold is one of: (a) 2860 MHz·km when the first wavelength is 844 nm and the first wavelength is provided by a laser having an RMS line width of 0.60 nm or less, (b) 2797 MHz·km when the first wavelength is 850 nm and the first wavelength is provided by a laser having an RMS line width of 0.60 nm or less, (c) 2733 MHz·km when the first wavelength is 857 nm and the first wavelength is provided by a laser having an RMS line width of 0.60 nm or less, or (d) 2684 MHz·km when the first wavelength is 863 nm and the first wavelength is provided by a laser having an RMS line width of 0.60 nm or less, and wherein the second effective modal bandwidth threshold is one of: (a) 2439 MHz·km when the second wavelength is 900 nm and the second wavelength is provided by a laser having an RMS line width of 0.58 nm or less, (b) 2420 MHz·km when the second wavelength is 905 nm and the second wavelength is provided by a laser having an RMS line width of 0.58 nm or less, (c) 2462 MHz·km when the second wavelength is 910 nm and the second wavelength is provided by a laser having an RMS line width of 0.58 nm or less, (d) 2386 MHz·km when the second wavelength is 915 nm and the second wavelength is provided by a laser having an RMS line width of 0.58 nm or less.

23. The method of claim 2, wherein the transmission distance is 90 meters, the first effective modal bandwidth threshold is one of: (a) 3200 MHz·km when the first wavelength is 844 nm and the first wavelength is provided by a laser having an RMS line width of 0.60 nm or less, (b) 3113 MHz·km when the first wavelength is 850 nm and the first wavelength is provided by a laser having an RMS line width of 0.60 nm or less, (c) 3025 MHz·km when the first wavelength is 857 nm and the first wavelength is provided by a laser having an RMS line width of 0.60 nm or less, or (d) 2959 MHz·km when the first wavelength is 863 nm and the first wavelength is provided by a laser having an RMS line width of 0.60 nm or less, and wherein the second effective modal bandwidth threshold is one of: (a) 2640 MHz·km when the second wavelength is 900 nm and the second wavelength is provided by a laser having an RMS line width of 0.58 nm or less, (b) 2616 MHz·km when the second wavelength is 905 nm and the second wavelength is provided by a laser having an RMS line width of 0.58 nm or less, (c) 2593 MHz·km when the second wavelength is 910 nm and the second wavelength is provided by a laser having an RMS line width of 0.58 nm or less, (d) 2573 MHz·km when the second wavelength is 915 nm and the second wavelength is provided by a laser having an RMS line width of 0.58 nm or less.

24. The method of claim 2, wherein the transmission distance is 100 meters, the first effective modal bandwidth threshold is one of: (a) 4113 MHz·km when the first wavelength is 844 nm and the first wavelength is provided by a laser having an RMS line width of 0.60 nm or less, (b) 3934 MHz·km when the first wavelength is 850 nm and the first wavelength is provided by a laser having an RMS line width of 0.60 nm or less, (c) 3761 MHz·km when the first wavelength is 857 nm and the first wavelength is provided by a laser having an RMS line width of 0.60 nm or less, or (d) 3637 MHz·km when the first wavelength is 844 nm and the first wavelength is provided by a laser having an RMS line width of 0.60 nm or less, and wherein the second effective modal bandwidth threshold is one of: (a) 3087 MHz·km when the second wavelength is 900 nm and the second wavelength is provided by a laser having an RMS line width of 0.58 nm or less, (b) 3049 MHz·km when the second wavelength is 905 nm and the second wavelength is provided by a laser having an RMS line width of 0.58 nm or less, (c) 3014 MHz·km when the second wavelength is 910 nm and the second wavelength is provided by a laser having an RMS line width of 0.58 nm or less, (d) 2981 MHz·km when the second wavelength is 915 nm and the second wavelength is provided by a laser having an RMS line width of 0.58 nm or less.

25. The method of claim 2, wherein the transmission distance is greater than or equal to 150 meters, the first effective modal bandwidth threshold is one of: (a) 4113 MHz·km when the first wavelength is 844 nm and the first wavelength is provided by a laser having an RMS line width of 0.60 nm or less, (b) 3934 MHz·km when the first wavelength is 850 nm and the first wavelength is provided by a laser having an RMS line width of 0.60 nm or less, (c) 3761 MHz·km when the first wavelength is 857 nm and the first wavelength is provided by a laser having an RMS line width of 0.60 nm or less, or (d) 3637 MHz·km when the first wavelength is 844 nm and the first wavelength is provided by a laser having an RMS line width of 0.60 nm or less, and wherein the second effective modal bandwidth threshold is one of: (a) 3087 MHz·km when the second wavelength is 900 nm and the second wavelength is provided by a laser having an RMS line width of 0.60 nm or less, (b) 3049 MHz·km when the second wavelength is 905 nm and the second wavelength is provided by a laser having an RMS line width of 0.60 nm or less, (c) 3014 MHz·km when the second wavelength is 910 nm and the second wavelength is provided by a laser having an RMS line width of 0.60 nm or less, (d) 2981 MHz·km when the second wavelength is 915 nm and the second wavelength is provided by a laser having an RMS line width of 0.60 nm or less.
